(19) United States
(12) Patent Application Publication
(10) Pub. No.: US 2003/0158876 A1
(43) Pub. Date: Aug. 21, 2003

(54) On-line randomness test through overlapping word counts

(75) Inventor: Laszlo Hars, Cortlandt Manor, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/081,910

(22) Filed: Feb. 21, 2002

(51) Int. Cl. G06F 7/58; G06F 1/02

(52) U.S. Cl. 708/250

(57) ABSTRACT

The present invention is a method and apparatus for testing random numbers generated by a random number generator in real time. As random numbers are generated, overlapping blocks of k bits undergo an exponential count operation one at a time, in which the count operation is performed by dropping the leftmost bit from the previous k bit block and appending a new random bit to the right of it to form a new k bit block, thus maintaining the size of the block. The binary value of this k bit block is used for performing the accumulator selection during the overlapping count operation. All of the outputs of the exponential averaging are compared to a predetermined acceptance range to determine whether the bits generated by the random number generator is sufficiently random.

### FIELD OF THE INVENTION

The present invention pertains to the field of random number generators and, in particular, to a digital data processing apparatus and method for analyzing the statistical quality of the random numbers generated in real time.

### BACKGROUND OF THE RELATED ART

A smart card is typically a credit-card-sized plastic card that includes a microprocessor embedded thereon to enable a variety of transactions. The card may include an encryption module for performing a variety of encryption algorithms to exchange information with other interfaces, i.e., card reading terminal. With the encryption module, signals from the card are routed to a number of metal contacts outside the card, which come in physical contact with similar contacts of a card reader terminal.

During the encryption mode, random number generators are used in some forms of cryptography to provide secured transmission of messages, such that only an intended receiving end can understand a message (i.e., voice or data) transmitted by an authorized transmitting end. However, as unauthorized receivers and unauthorized transmitters become more sophisticated in breaking the generation process of the random numbers that are used in encryption of messages, the need becomes greater for generating unpredictable random numbers for secured communications.

In addition to the security breach caused by unauthorized parties, the random number generator may generate non-random numbers during operation. For example, heat is generated in the hardware component of the random number generator when it generates a series of 1's and 0's over the time period. Generating a 1 bit could consume more power than a 0 bit. If a long sequence of 1 bits is generated, the electrical circuit becomes hot. At this time, if the circuit generates a 1 bit when it is hot, the circuit will “latch up”, that is, it generates almost always 1 bits and very rarely a 0 bit. A different effect may occur if a 0 bit is generated when the circuit is hot. In this case a long sequence of 1 bits becomes too rare, which constitute a non-random property. In cryptographic applications this may have catastrophic consequences: the security will be breached. Accordingly, both the detection of hardware tampering and the detection of malfunction of the circuit are necessary when conducting randomness tests.

### SUMMARY OF THE INVENTION

The present invention detects the above-described and other problems, and provides additional advantages by providing a method and apparatus for an on-line randomness test so that generated random numbers are less susceptible to crypto-analysis by an unauthorized party.

According to an aspect of the invention, a method for testing randomness when generating random numbers is provided. The method includes the steps of: generating random sequences of binary bits; applying a predefined block of k bits to an overlapping count operation at a time to compute the average number of occurrences of each possible k bit long block; and, determining whether the frequency of occurrences of each block of k bits is within a predetermined acceptance range. The method further includes the steps of: upon determining that the frequency of occurrences of at least one of the predefined blocks of k bits fall outside the predetermined acceptance range notifying that the generated random sequences are insufficiently random; and, generating a new set of random numbers when at least one of the predefined blocks of k bits falls outside of the predetermined acceptance range.

According to another aspect of the invention, a method for testing the output of a random number generator is provided. The method includes the steps of: (a) generating a series of binary bits using the random number generator; (b) performing and tracking an overlapping count operation for each possible predetermined block of k bits at predefined time intervals; (c) computing an exponential averaging A for each of the tracked overlapping count operation at the predefined time interval; (d) comparing the computed exponential averaging to a predetermined acceptance range; and, (e) determining that the generated binary numbers are sufficiently random when the computed exponential averaging falls inside the predetermined acceptance range. The method further includes the steps of: repeating the steps (a)-(d) until any of the computed exponential averaging falls outside of the predetermined acceptance range; notifying that non-random numbers are generated when the test in step (d) fails repeatedly more than a threshold value; and, generating a new set of random numbers when the test in step (d) fails repeatedly more than a predefined number of times.

According to a further aspect of the invention, an apparatus is provided for testing the randomness of a sequence of random numbers. The apparatus includes a random number generator unit for generating substantially random sequences of binary bits; and, a detector unit, coupled to the output of the random generator unit, for detecting whether the generated random sequences are sufficiently unpredictable, wherein a predefined block of k bits is applied to an overlapping exponential count operation, one at a time to compute the average number of occurrences of each possible k bit block wherein, if the output of any of the exponential accumulators A falls outside of it's a predetermined acceptance range, determining that the generated random sequences are non-random. The apparatus further includes a switch unit, coupled to the outputs of the random generator unit and the detector unit, for passing the generated random sequences for a subsequent application when the generated random sequences are determined to be sufficiently random, and means for transmitting an alarm signal when the value of any of the exponential accumulators A falls outside of its predetermined acceptance range.

Yet another aspect is that the present invention may be implemented in hardware, in software, or in a combination of hardware and software as desired for a particular application.

Still another aspect is that the present invention may be realized in a simple, reliable, and inexpensive implementation.

Still another aspect is that the present invention increases the security of a random number generator that is embedded in a smart card.

The foregoing and other features, and advantages of the invention will be apparent from the following, more detailed description of preferred embodiments as illustrated in the accompanying drawings.

### BRIEF DESCRIPTION OF DRAWINGS

FIG. 1 illustrates a simplified block diagram of the random generating module according to an embodiment of the present invention;

FIG. 2 shows a diagram showing the overlapping counting of random sequences according to an embodiment of the present invention; and,

FIG. 3 is a flow chart illustrating the operation steps of testing the statistics of the generated random numbers according to an embodiment of the present invention.

### DETAILED DESCRIPTION OF THE EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For purposes of simplicity and clarity, detailed descriptions of well-known devices, circuits, and methods are omitted so as not to obscure the description of the present invention with unnecessary detail.

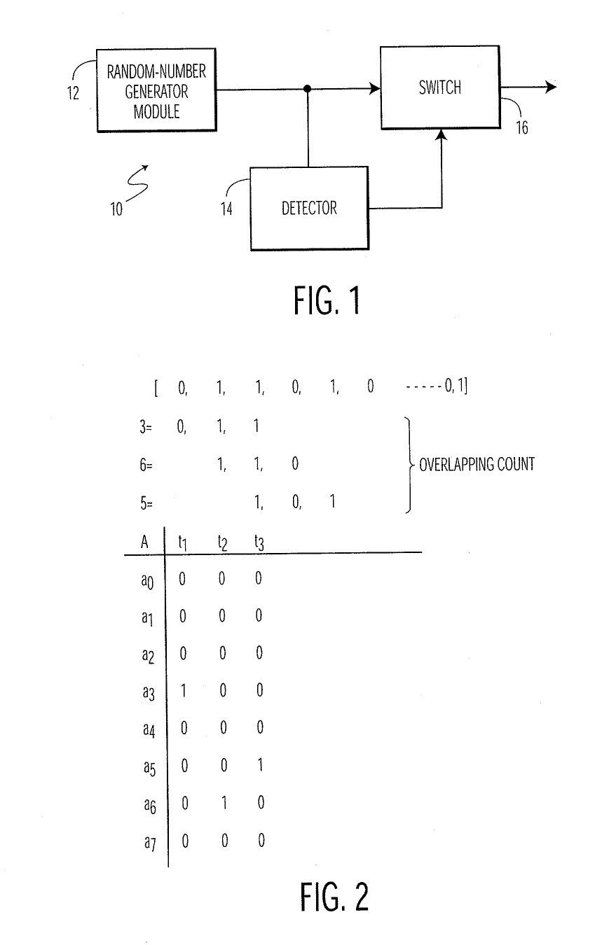

FIG. 1 depicts a functional block diagram of a random generating system 10 for testing some statistical properties of the generated random numbers in real time according to an exemplary embodiment of the present invention. The system 10 includes a random-number generating module (RG) 12, a detector 14, and a switch 16. The RG module 12 is operable to output a series of random numbers. It should be noted that generating random numbers is well known in the art and can be performed in a variety of ways. The detector 14 detects the generated random numbers outputted by the RG 12 for its randomness according to predetermined criteria (explained later); if it passes, the switch 16 allows the generated random numbers for a subsequent application, such as any circuit, system, process, application, or the like which uses the random numbers supplied by the RG 12. The switch 16 is de-activated, under the control of the detector 14, to stop the transmission of the generated random numbers when the generated random numbers are deemed inadequately random. The switch 16 may represent an input to a cryptographic system, an audio or video noise generator, a computer program, or other devices and processes. For example, the random number generating system 10 is operable to provide secret data, which in cryptographic protocols are used to establish cryptographic keys for confidential communication between the transmitting end and to an authorized receiving end, like in the well-known Diffie-Hellman secret sharing protocol. The random numbers could be used to generate cryptographic keys to encrypt or decrypt message segments, therefore allowing the intended receiver to comprehend the transmitted message. In addition to the formation of an encrypted signal, the testing of the random numbers according to the techniques of the present invention may be used in other implementations, i.e., gambling, simulation, statistical sampling, etc., in which random numbers are utilized.

A random number generator is considered secure if, given one or more random numbers, any other bit of the generated random sequence would be impossible to predict with more than 50% probability. Accordingly, a key principle of the present invention involves testing the RG module 12 given one or more random numbers. In particular, the output of the random-sequence generated is analyzed by the detector 14 to ensure that the generated random numbers will be unpredictable by an unauthorized party.

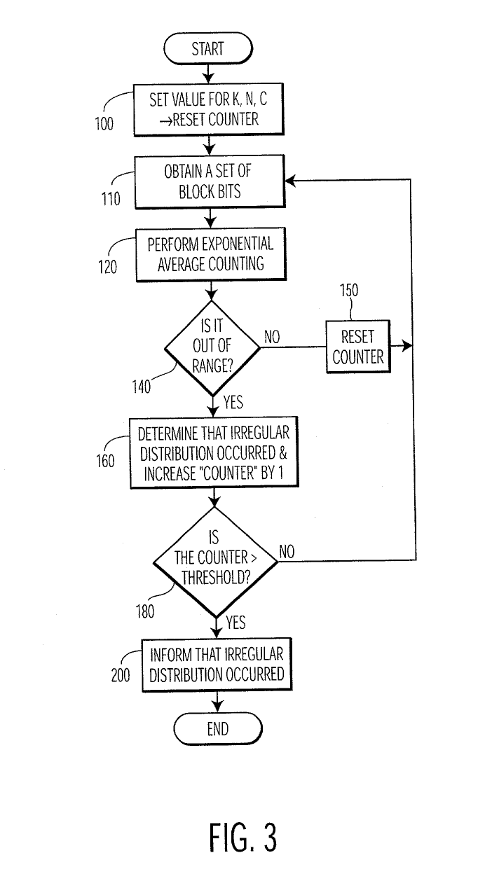

Now, a description will be made in detail in regards to testing the statistical quality of the random sequence with reference to FIGS. 2 and 3.

Referring to FIG. 2, the random numbers are tested in real time while the RG module 12 is in operation to ensure that the generated random numbers are appropriate according to an embodiment of the present invention. As such, the present invention can be easily implemented in software where there is a microprocessor and the random sequence generator is integrated in a device, such as a smart card, thus the tests require only few lines of additional codes and little memory. The randomness test begins by initializing the exponential average accumulators. As shown in FIG. 2, a continuous stream of random values, generated by the RG module 12 undergoes an overlapping count operation, in which a preset block of bits, k, is entered into a ring buffer to aid performing the exponential-average computation. The average number of occurrences for each k bit block of random sequence is updated one at a time by adding 1 to the corresponding accumulator, A, and 0 to the other accumulators, while reducing all of them by a constant factor α (explained later). Thus, the present invention uses a plurality of accumulators containing the frequency of occurrences for all the possible different k bit blocks. Note that an initial value is assigned to each accumulator. For example, if k=3, the first block of the random sequence is (0, 1, 1), the corresponding binary value is 3. It should be noted that the value of k is set to 3 for illustrative purposes. Thus, it is to be understood that the value of k in the drawing should not impose limitations on the scope of the invention. The second block of the random sequence is (1, 1, 0), the corresponding binary value is 6. For the third random sequence block of (1, 0, 1), the corresponding binary value is 5. Each time a new random bit is generated, the block of bits of the previously collected ones is shifted to the right, the leftmost bit is dropped and the new bit is appended to the right. In this way we determine the overlapping blocks of k bits, needed to select the accumulator used for calculating the number of occurrences for each k bit block.

In the embodiment, each time a new k bit block is generated and the corresponding binary indexing value is computed while the indexed accumulator A is updated, it is determined whether the generated random numbers will be sufficiently random as to the number of block occurrences are roughly the same. That is, all possible k-bit words should appear in the sequence roughly as equally often. To this end, a predetermined range value is compared to the value of each accumulator. If the value of any accumulator falls out of the predetermined range during the exponential averaging counting, it is inferred that the generated random numbers would be predictable to an unauthorized party.

Note that as the present invention is applicable in real time to test the random sequence, the old block counting values should have a diminishing or no effect. That is, the test to evaluate the statistical quality of the random sequence runs continuously, thus the counters must be cleared periodically. There are various counting methods that can be implemented in accordance with the techniques of the present invention; however, exponential averaging is preferably used during the overlapping counting operation, as described below.

If an accumulator A is used to obtain an average occurrence value each time the random numbers are generated, a factor, α, which falls between 0 and 1 (0<α<1), is multiplied to A and then an indicator value b is added: A_{new}=α·A_{old}+b. In counting applications b=1 if the event occurred, otherwise set to 0. To have useful averaging effects, the value for a is selected to be close to 1,α=1−1/n,n>>1. In this case, log α≈−1/n and the half-life of the averaged bit is k≈n·log 2≈0.30103·n. After n bits the weight of the oldest bit becomes (1−1/n)ⁿ≈1/e≈0.367879. Here, e is the basis of the natural logarithm (the Euler constant), so the term, n, becomes the natural life of a bit. If all bits were 1's, the accumulator value is 1+α+α²+ . . . =1/(1−α)=n, whereas if all bits were 0's the accumulator value is 0. Note that the expected value of the exponential average is the exponential average of the expected values of the individual bits: ½+½α+½α²+ . . . =n/2. If every other bit was 1, the accumulator value alternates between 1+α²+α⁴+ . . . =1/(1−α²) and α+α³+α⁵+ . . . =α/(1−α²), which are very close to ½ apart [n/(2n−1)], whose mean value is also (1+α)/2(1−α²)=n/2.

As described above, the exponential averaging serves to clear the counter as the accumulator is decreased with a certain 0<α<1 factor; thus, the accumulator never becomes too large during the operation mode. Once the exponential averaging is performed for each accumulator, the value of exponential averaging is compared to a predetermined acceptance range, which is derived as explained hereinafter.

It is easy to see that if the sequence R was truly random, the number of occurrences for a particular k-bit block in sequence of the length n are close to normally distributed with μ=n/2^{k+1} and σ=\sqrt{n}/2^{k+1}. Note that the standard deviation of a single unbiased random bit is σ=1/2. Thus, the square of the standard momentum D² is a linear function, as follows: D²(b₀+αb₁+α²b₂+ . . . )=D²(b₀)+αD²(b₁)+α²D²(b₂)+ . . . =¼+¼α+¼α²+ . . . =n/4.

Consequently, the standard deviation of the exponential average with the parameter α=1−1/n (natural life n) of random 0/1 bits is σ=\sqrt{n}/2, which is the same as the standard deviation of the arithmetic mean of n elements. Hence, the number of occurrences of each block should fall into the interval,

[n/2^{k+1}−c·\sqrt{n}/2^{k+1}, n/2^{k+1}+c·\sqrt{n}/2^{k+1}] (1),

with the following probabilities:

| c | P in % |
|---|---|
| 1 | 68.26895 |
| 2 | 95.44997 |
| 3 | 99.73002 |
| 4 | 99.99367 |
| 5 | 99.99994 |

Note that in testing the statistics of a random sequence, the number of block occurrences must be roughly the same. Here, “roughly” means taking n samples whose block occurrences must fall between [n/2^{k+1}−c·\sqrt{n}/2^{k+1}, n/2^{k+1}+c·\sqrt{n}/2^{k+1}]. The constant c controls what percentage of all of the sequences will fall into the interval (c/2=1 gives 68.3%, c/2=2 gives 95.4%, c/2=3 gives 99.7% etc.). The value of k and n are pre-selected by the operator or prefixed so that a good trade-off between the complexity and the strength of the test may be optimized. Note here that obtaining the predetermined range of [n/2^{k+1}−c·\sqrt{n}/2^{k+1}, n/2^{k+1}+c·\sqrt{n}/2^{k+1}] that is used for testing non-randomness is determined by extensive simulations with a good known source of random numbers.

If the exponential averaging accumulator falls out of the predetermined range, it indicates that the sequence shows an irregular word distribution. Then, an alarm may be transmitted to the user to notify that the sequence may not be random or susceptible to crypto-analysis by an unauthorized party. Alternatively, a threshold value may be set to notify the user when the test fails repeatedly. As such, the exponential averaging limits can be initiated using a set of random sequences to determine whether the generated random sequence falls between the acceptable range, which is controllably set by an operator, so that a determination can be made as to whether the generated random sequence is predictable to an unauthorized party. In addition, a further step of testing the randomness can be achieved based on the distribution of the calculated exponential averaging values over the predetermined acceptance range. That is, the exponential averaging values must fall evenly within the predetermined acceptance range. Each time the exponential averaging value is calculated, it is monitored as to what part of the acceptance range it falls under, for example, the left half or the right half of the acceptance range. If the frequency of falling in the left half is roughly equal to the right half, then this parameter can be used as an indication that the generated random numbers will be unpredictable.

FIG. 3 is a flow chart illustrating the operation steps of testing the statistical quality of the random sequence in accordance with the present invention. The rectangular elements indicate computer software instruction, whereas the diamond-shaped element represents computer software instructions that affect the execution of the computer software instructions represented by the rectangular blocks. Alternatively, the processing and decision blocks represent steps performed by functionally equivalent circuits such as a digital signal processor circuit or an application-specific integrated circuit (ASIC). It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention.

Initially, the values for k, n, and c (in equation 1) are prefixed or pre-selected by an operator and the counter is reset in step 100. Then, a block k-bits is obtained in step 110, and the exponential average counting is performed subsequently in step 120. Each time a new random bit is generated, the block of the previously collected bits gets shifted to the right, and the leftmost bit is dropped while the new bit is appended to the right. The resulting block as a binary number is used to index the accumulator, A, among 2^{k} accumulators. In step 140, if the value of the exponential averaging accumulator deviates from the acceptance range chosen in step 100, it is determined that irregular distribution occurs in the random sequence in step 160 and the counter is incremented by one. Otherwise, the counter is reset in step 150 and returned to step 110. If irregular distribution occurred more than a predetermined threshold times in step 180, a notice to such failure is provided in step 200. Alternatively, the generated random numbers can be discarded, and the whole process of generating new random numbers can be initiated.

The various steps described above may be implemented by programming them into functions incorporated within application programs, and programmers of ordinary skill in the field can implement them using customary programming techniques in languages, such as C, Visual Basic, Java, Perl, C++, and the like. In an exemplary embodiment, the method described in FIG. 3 may be constructed as follows (using the C programming language).

[image]

[image]

While the preferred embodiments of the present invention have been illustrated and described, it will be understood by those skilled in the art that various changes and modifications may be made and equivalents substituted for elements thereof without departing from the true scope of the present invention. In addition, many modifications can be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A method for testing randomness when generating a random number, the method comprising the steps of:
generating random sequences of binary bits;
applying said generated random sequences to an exponential overlapping count operation A at a predefined block interval of k bits at a time to compute an average number of occurrences for each said predefined block; and,
determining whether said generated random sequences are sufficiently random by comparing the output of said exponential overlapping count operation A to a predetermined acceptance range.

2. The method of claim 1, further comprising the step of determining that said generated sequences are sufficiently random when the output of said exponential overlapping count operation A falls between said predetermined acceptance range.

3. The method of claim 1, further comprising the step of notifying that said generated random sequences are not sufficiently random when the output of said exponential count operation A falls outside of said predetermined acceptance range.

4. The method of claim 3, further comprising the step of generating a new set of random sequences when the output of said exponential count operation A falls outside of said predetermined acceptance range.

5. The method of claim 1, wherein said exponential averaging count operation A is updated according to the following equation:
A_{new}=α·A_{old}+b,
wherein α=1−1/n, and α falls between 0 and 1 (0<α<1), and wherein
b=1 if the binary value of the k bit block occurs, otherwise b=0.

6. The method of claim 1, wherein said exponential overlapping count operation is performed each time a new random bit is generated by dropping the leftmost bit from said predefined block of k bits and appending said new random bit to the right of said predefined block of k bits.

7. The method of claim 5, wherein said predetermined acceptance range is defined as follows:
[n/2^{k+1}−c·\sqrt{n}/2^{k+1}, n/2^{k+1}+c·\sqrt{n}/2^{k+1}],
where c is selected to achieve a desired security threshold level.

8. A method of testing an output of a random number generator, the method comprising the steps of:
(a) generating a continuous stream of binary bits using said random number generator;
(b) performing and tracking an overlapping exponential count operation on a predetermined block of k bits at a predefined time interval for each bit to obtain a corresponding frequency value;
(c) comparing all said computed exponential averaging values A a predetermined acceptance range; and,
(d) determining that said generated binary numbers are non-random when any one of said computed exponential averaging values falls outside of said predetermined acceptance range.

9. The method of claim 8, further comprising the step of:
repeating said steps (a)-(c) until any of the said computed exponential averaging value falls outside of said predetermined acceptance range.

10. The method of claim 9, further comprising the step of notifying that non-random numbers are generated when said computed exponential averaging falls outside of said predetermined acceptance range repeatedly more than a predetermined number of times.

11. The method of claim 9, further comprising the step of generating a new set of random numbers when said computed exponential averaging falls outside of said predetermined acceptance range repeatedly more than a threshold value.

12. The method of claim 8, wherein said random number generator is embedded in a smart card.

13. The method of claim 8, wherein said exponential averaging A is defined by:
A_{new}=α·A_{old}+b,
wherein α=1−1/n and α falls between 0 and 1 (0<α<1),
wherein b is a value comprising 1 if the binary value of the k bit block occurs in said step (b), otherwise 0.

14. The method of claim 8, wherein said overlapping count operation is performed each time a new random bit is generated by dropping the leftmost bit from said predetermined block of k bits and appending said new random bit to the right of said predetermined block of k bits.

15. The method of claim 13, wherein said predetermined acceptance range is defined as follows:
[n/2^{k+1}−c·\sqrt{n}/2^{k+1}, n/2^{k+1}+c·\sqrt{n}/2^{k+1}],
where c is selected to achieve a desired security threshold level.

16. An apparatus for testing the randomness of a random number sequence, comprising:
a random generator unit for generating substantially random sequences of binary bits; and,
a detector unit, coupled to the output of said random generator unit, for detecting whether said generated random sequences are sufficiently random,
wherein said generated random sequences are applied to an exponential overlapping count operation A at a predefined block interval of k bits to compute an average number of occurrences for each said predefined block, and wherein if the output of said exponential overlapping count operation A falls outside of a predetermined acceptance range, determining that said generated random sequences are insufficiently random.

17. The apparatus of claim 16, further comprising a switch unit, coupled to the outputs of said random generator unit and said detector unit, for passing said generated random sequences for a subsequent application when said generated random sequences are determined to be sufficiently random.

18. The apparatus of claim 16, further comprising means for transmitting an alarm signal when the output of said exponential overlapping count operation A falls outside of said predetermined acceptance range.

19. The apparatus of claim 16, wherein said exponential overlapping count operation A is computed according to the following equation:
A_{new}=α·A_{old}+b,
where α=1−1/n, and α falls between 0 and 1 (0<α<1),
b=1 if the binary value of the k bit block occurs, otherwise b=0 , and
A_{old} is preset initially by an operator.

20. The apparatus of claim 19, wherein said predetermined acceptance range is defined as follows:
[n/2^{k+1}−c·\sqrt{n}/2^{k+1}, n/2^{k+1}+c·\sqrt{n}/2^{k+1}],
where c is selected to achieve a desired security threshold level.

21. A machine-readable medium having stored thereon data representing sequences of instructions, and the sequences of instructions which, when executed by a processor, cause the processor to:
generate a stream of random numbers of binary bits;
compute and track an exponential overlapping count operation on a predetermined block of k bits at a predefined time interval for each bit to obtain a corresponding binary value; and,
compare all said computed exponential averaging A to a predetermined acceptance range to determine whether said generated random numbers are sufficiently random.

22. The machine-readable medium of claim 21, wherein said generated binary numbers are not sufficiently random when said computed exponential averaging falls outside of said predetermined acceptance range.

23. The machine-readable medium of claim 21, wherein said exponential averaging A is defined by:
A_{new}=α·A_{old}+b,
wherein α=1−1/n and α falls between 0 and 1 (0<α<1),
wherein b is a value comprising 1 if the binary value of the k bit block occurs, otherwise 0.

24. The machine-readable medium of claim 21, wherein said overlapping count operation is performed each time a new random bit is generated by dropping the leftmost bit from said predetermined block of k bits and appending said new random bit to the right of said predetermined block of k bits.

25. The machine-readable medium of claim 23, wherein said predetermined acceptance range is defined as follows:
[n/2^{k+1}−c·\sqrt{n}/2^{k+1}, n/2^{k+1}+c·\sqrt{n}/2^{k+1}],
where c is selected to achieve a desired security threshold level.
